(19) United States
(12) Patent Application Publication
(10) Pub. No.: US 2022/0076172 A1
(43) Pub. Date: Mar. 10, 2022

(54) FITTING ROOM RESERVATION SYSTEM FOR CONTACT MINIMIZATION IN RETAIL CONTEXT

(71) Applicant: Target Brands, Inc., Minneapolis, MN (US)

(72) Inventors: AMANDA BROWN, Minneapolis, MN (US); DANIEL PRUSINSKI, Minneapolis, MN (US); TAYLOR SLY, Lake Elmo, MN (US); ALEX STOPPEL, Minneapolis, MN (US)

(21) Appl. No.: 17/471,792

(22) Filed: Sep. 10, 2021

Related U.S. Application Data
(60) Provisional application No. 63/149,864, filed on Feb. 16, 2021.
(60) Provisional application No. 63/076,717, filed on Sep. 10, 2020.

(51) Int. Cl. G06Q 10/02; G06Q 30/06

(52) U.S. Cl. CPC G06Q 10/02; G06Q 30/0643

(57) ABSTRACT

Methods and systems for implementing a reduced contact fitting room reservation system are described. In example implementations, a customer may digitally select one or more apparel items to be assessed at a physical retail location. The customer may also select the specific location, as well as a notice (e.g., a date and time range) for the time at which the customer is likely to arrive at the retail location. Upon receipt of the selection of apparel items and the notice at the physical retail location, an employee may also sanitize a particular fitting room, and also collect the selected items and place those items in the particular fitting room for assessment by the customer.

### CROSS-REFERENCE TO RELATED APPLICATIONS

This application claims priority from U.S. Provisional Application Ser. No. 63/149,864, filed Feb. 16, 2021, and titled “Fitting Room Reservation System for Contact Minimization in Retail Context;” and U.S. Provisional Application Ser. No. 63/076,717, filed Sep. 10, 2020, and titled “Fitting Room Reservation System for Contact Minimization in Retail Context,” which applications are hereby incorporated herein by reference in their entirety.

### BACKGROUND

Increasingly, retail customers are seeking ways in which they may minimize an amount of time spent in a retail establishment. This may be, for example, due to lack of time, inconvenience, or to minimize the extent to which they interact with others or touch other services or products. For example, in times in which highly communicable diseases are transmitted throughout the public (e.g., the COVID-19 pandemic, and the like) it is desirable to minimize interaction between people, as well as minimize contact with items or surfaces that may be touched by many other customers.

In many cases, for commodity items, if a customer does not need to touch or feel the item prior to purchase. However, in some contexts, it may be desirable for the customer to physically view or assess in person the item to be purchased. This is particularly the case for apparel, which is often tried on prior to purchase. Although some existing systems attempts to overcome this limitation by shipping a collection of items of different sizes or styles to a user and providing a return envelope for unwanted items, this can be an inefficient because shipping and return costs may be substantial. Additionally, a user who simply wishes to adjust for a different size may not wish to ship multiple items of the same type but only of different sizes to himself or herself, because that user knows that he or she may then be required to be inconvenienced by having to return the unwanted size of the particular item.

### SUMMARY

In general, methods and systems for implementing a reduced contact fitting room reservation system are described. In one example aspect, a customer may digitally select one or more apparel items to be assessed at a physical retail location. The customer may also select the specific location, as well as a notice (e.g., a date and time range) for the time at which the customer is likely to arrive at the retail location. Upon receipt of the selection of apparel items and the notice at the physical retail location, an employee may also sanitize a particular fitting room, and also collect the selected items and place those items in the particular fitting room for assessment by the customer.

In accordance with certain aspects of the disclosure, the retail provider computing system enables a user of a customer device to search for apparel items and reserve a selection of one or more of the apparel items to “try on” in a dressing room at a particular retail provider location (e.g., store).

In certain implementations, the retail provider computing system is configured to store a reservation basket in association with a particular user upon request of the particular user. The reservation basket includes a customer identification that enables the user to be matched to the reservation basket. The reservation basket also includes a location identifier that indicates a particular retail location. The reservation basket also may include a selection of one or more items (e.g., items available at the particular retail location).

In accordance with certain aspects of the disclosure, the retail provider computing system enables the retail provider to track multiple reservations for different users and to pull (i.e., collect and optionally place in a fitting room) the reserved apparel items prior to the arrival of each user. In certain implementations, the retail provider computing system schedules sanitizing of a reserved fitting room (or a fitting room available at a reserved time) prior to the arrival of a respective user.

In some implementations, the retail provider computing system assigns a particular fitting room to the reservation. In other implementations, the retail provider computing system monitors a number of available fitting rooms for a particular timeframe and decrements the number of available fitting rooms for each reservation for that timeframe.

In accordance with certain aspects of the disclosure, a retail provider computing system includes a customer interface system (or module), an inventory management system (or module), and a fitting room reservation system (or module). The customer interface system communicates with one or more customer devices (e.g., mobile devices, home computers, public computers, etc.). The customer interface system also communicates with the inventory management system and the fitting room reservation system.

### BRIEF DESCRIPTION OF THE DRAWINGS

FIG. 1 illustrates an example computing system with which aspects of the present disclosure may be implemented.

FIG. 2 is a process flow chart for reduced contact fitting room reservations in a retail context, according to an example implementation.

FIG. 3 is a diagram of example advantages of the reduced contact fitting room reservation system described herein.

FIG. 4 illustrates a first user interface displayable on a user mobile device to implement reduced contact fitting room reservations.

FIG. 5 illustrates a second user interface displayable on a user mobile device to implement reduced contact fitting room reservations.

FIG. 6 illustrates a third user interface displayable on a user mobile device to implement reduced contact fitting room reservations.

FIG. 7 illustrates a fourth user interface displayable on a user mobile device to implement reduced contact fitting room reservations.

FIG. 8 illustrates a fifth user interface displayable on a user mobile device to implement reduced contact fitting room reservations.

FIG. 9 illustrates a sixth user interface displayable on a user mobile device to implement reduced contact fitting room reservations.

FIG. 10 illustrates a user interface displayable on an employee mobile device to implement reduced contact fitting room reservations.

FIG. 11 illustrates an example computing network connecting various customer devices to a retail provider computing system.

FIG. 12 illustrates an example computing environment for a customer interface system suitable for use in the retail provider computing system of FIG. 11.

FIG. 13 illustrates customer data that can be stored in memory of the customer interface system shown in FIG. 12.

FIG. 14 illustrates information stored by the virtual reservation basket of FIG. 13.

FIG. 15 illustrates a flow chart of an example reservation process to be implemented by a user to reserve one or more items to be tried on in a fitting room at a select retail provider location at a selected timeframe.

FIG. 16 illustrates a flow chart of an example scheduling process to be implemented by the customer interface system of FIG. 12 to reserve a fitting room for a user.

FIG. 17 illustrates an example computing environment for an inventory management system suitable for use in the retail provider computing system of FIG. 11.

FIG. 18 illustrates a flow chart of an example check process to be implemented by the inventory management system to determine whether items selected by a user are available at a retail provider location selected by the user.

FIG. 19 illustrates a flow chart of an example update process to be implemented by the inventory management system to update an item identifier to reflect that the item (or one of the item types) has been reserved.

FIG. 20 illustrates an example computing environment for a reservation system suitable for use in the retail provider computing system of FIG. 11.

FIG. 21 illustrates an example implementation of fitting room scheduling data associated with a particular retail provider location, the reservation data to be stored in the memory of the reservation system of FIG. 20.

FIG. 22 illustrates example reservation data to be stored in the memory of the reservation system to represent a particular reservation by a particular user for a particular timeframe at a particular retail location.

FIG. 23 illustrates a flow chart for an example reservation process to be implemented by the reservation system to schedule a fitting room at a particular retail provider location.

FIG. 24 illustrates an example user interface displays a category of apparel items and providing a reserve option.

FIG. 25 illustrates another example user interface displaying search results based on criteria supplied by the user and providing a reserve option.

FIG. 26 illustrates another example user interface displaying information about a selected apparel item and providing a reserve option.

### DETAILED DESCRIPTION

As briefly described above, embodiments of the present invention are directed to methods and systems for remote self-checkout are described. One method includes presenting an identifier at a self-checkout point of sale device that may be captured by a user mobile device. The self-checkout point of sale device and the user mobile device may be linked to a user cart. Scans of codes of fixed to items to be purchased may then be performed using either the user mobile device or the self-checkout point of sale device, and payment may also be performed on either device. Accordingly, contact with a self-checkout point of sale device may be reduced.

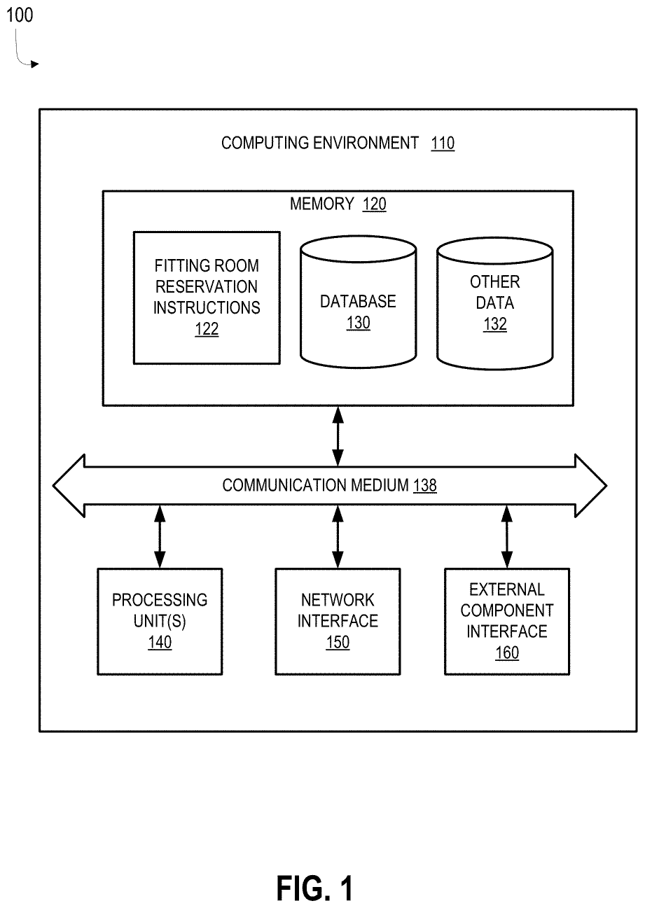

FIG. 1 illustrates an example computing system 100 with which aspects of the present disclosure may be implemented. In an example, a user mobile device, a point of sale, a server, or other interacting computing devices can be implemented as one or more systems 100 or one or more systems having one or more components of systems 100. In an example, the system 100 can include a computing environment 110. The computing environment 110 can be a physical computing environment, a virtualized computing environment, or a combination thereof. The computing environment 110 can include memory 120, a communication medium 138, one or more processing units 140, a network interface 150, and an external component interface 160.

The memory 120 can include a computer readable storage medium. The computer storage medium can be a device or article of manufacture that stores data and/or computer-executable instructions. The memory 120 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The memory 120 can store various types of data and software. For example, as illustrated, the memory 120 includes instructions 122 for implementing a reduced contact fitting room reservation system, as well as a database 130 as well as other data 132. In some examples (e.g., where the computing environment 110 is a customer's user device), the memory 120 can include instructions for selecting items and reserving a fitting room for use. In some examples, the memory 120 can include instructions for receiving such item selections and facilitating employee notifications to prepare the fitting room for the prospective customer.

The communication medium 138 can facilitate communication among the components of the computing environment 110. In an example, the communication medium 138 can facilitate communication among the memory 120, the one or more processing units 140, the network interface 150, and the external component interface 160. The communications medium 138 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 140 can include physical or virtual units that selectively execute software instructions. In an example, the one or more processing units 140 can be physical products comprising one or more integrated circuits. The one or more processing units 140 can be implemented as one or more processing cores. In another example, one or more processing units 140 are implemented as one or more separate microprocessors. In yet another example embodiment, the one or more processing units 140 can include an application-specific integrated circuit (ASIC) that provides specific functionality. In yet another example, the one or more processing units 140 provide specific functionality by using an ASIC and by executing computer-executable instructions.

The network interface 150 enables the computing environment 110 to send and receive data from a communication network (e.g., network 104). The network interface 150 can be implemented as an Ethernet interface, a token-ring network interface, a fiber optic network interface, a wireless network interface (e.g., WI-FI), or another type of network interface.

The external component interface 160 enables the computing environment 110 to communicate with external devices. For example, the external component interface 160 can be a USB interface, Thunderbolt interface, a Lightning interface, a serial port interface, a parallel port interface, a PS/2 interface, and/or another type of interface that enables the computing environment 110 to communicate with external devices. In various embodiments, the external component interface 160 enables the computing environment 110 to communicate with various external components, such as external storage devices, input devices, speakers, modems, media player docks, other computing devices, scanners, digital cameras, and fingerprint readers.

Although illustrated as being components of a single computing environment 110, the components of the computing environment 110 can be spread across multiple computing environments 110. For example, one or more of instructions or data stored on the memory 120 may be stored partially or entirely in a separate computing environment 110 that is accessed over a network.

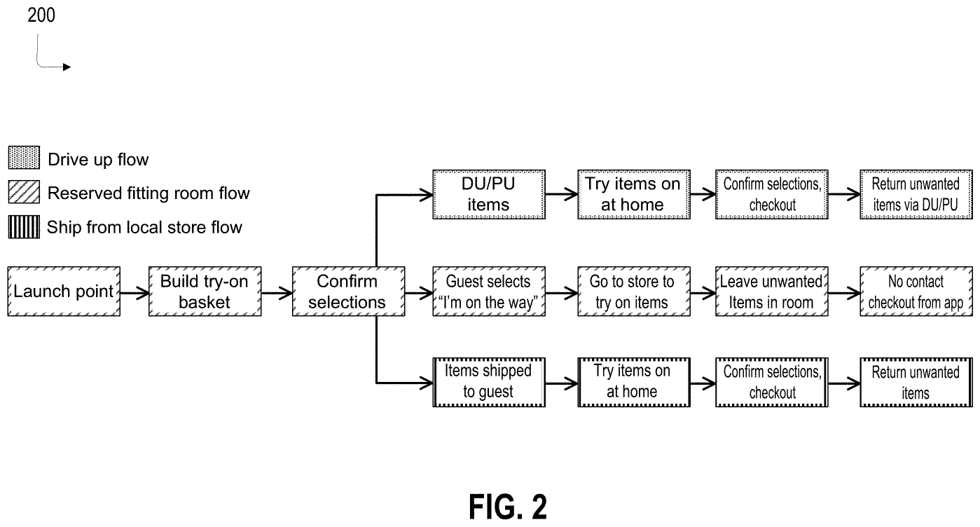

FIG. 2 is a process flowchart 200 for reduced contact fitting room reservations in a retail context, according to example implementations. As seen in the flow chart 200, the user may initiate a reduced contact fitting room reservation from a launch point, e.g. From a user mobile device or online retail website. The user will build a try on basket including one or more items to be placed in a fitting room. The user will then confirm the selections of the one or more items. The items may be, for example, apparel items.

At this point, a user may have many options as to how to assess the selected items. In one example the user may opt to use a drive up/pickup process in which the user, collects the items, tries those items on at home, confirms selections of desired items and performs a checkout process, and returns any unwanted items, again via a drive up/drop off process. In this way, the user is able to assess the items and home without significant contact with others or services at the retail location.

In a second example, the user may opt to select a shipping option, in which the selected items are shipped to the user, and the user tries on those items at home, confirms selections of desired items and performs a checkout process, and returns unwanted items (e.g., by a selected shipping option). While a higher cost process this reduces contact with others at retail location even further.

In accordance with the new present disclosure, a further example is made possible in which the user selects a retail location and notifies at that the user is on their way to try on particular apparel items. The user then goes to the retail location, tries on items in a reserved, sanitized fitting room, leaves any unwanted items in the fitting room, and performs a no contact checkout process, e.g. from a mobile application. In this process, the user is able to avoid the inconvenience of multiple shipping steps or return steps by visiting the retail location one time, and is also not inconvenienced by having unwanted items shipped to their home.

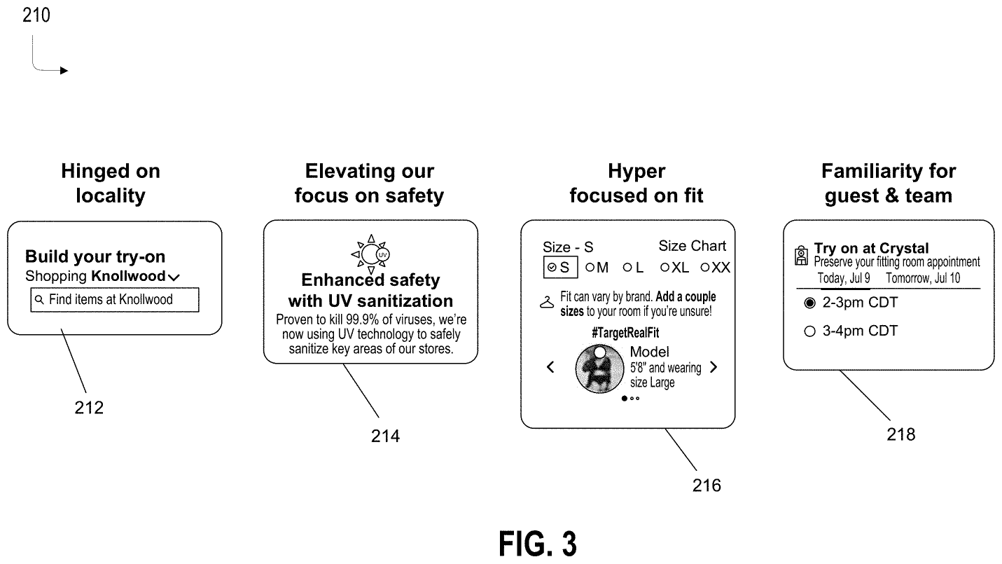

FIG. 3 is a diagram 210 of example advantages of the reduced contact fitting room reservation system described herein. As seen in FIG. 3, the option of allowing a user to try on items in a reservable fitting room improves locality (see user interface 212), improves the safety for those users who wish to have an in store experience (see user interface 214), ensures the user obtains an item that they are happy with by focusing on the fit of the item (see user interface 216), and provides as you near to a normal shopping experiences possible while minimizing contact with others or potentially with non-sanitized services at a retail location (see user interface 218).

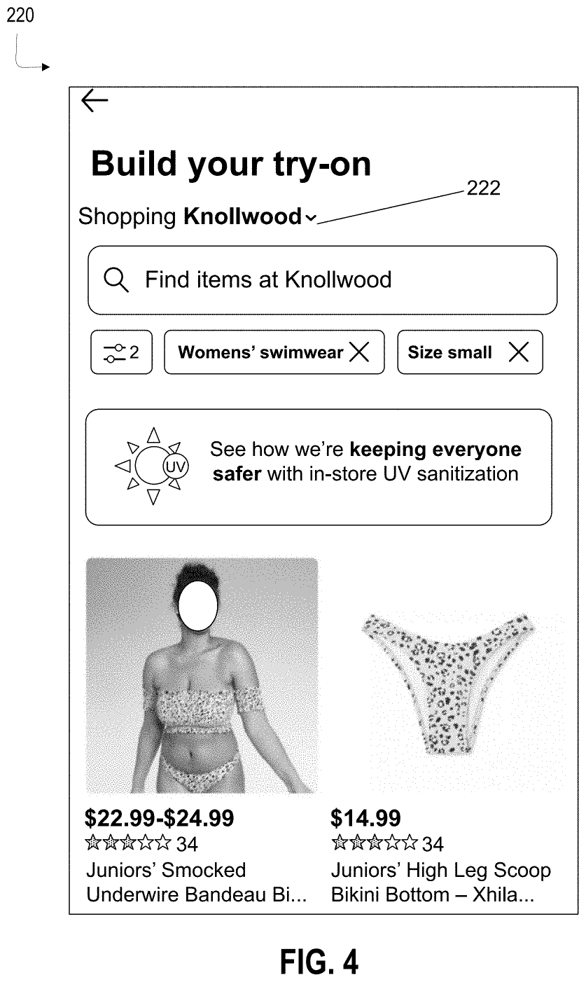

Referring now to FIGS. 4-10, user interfaces are shown that facilitate the fitting room reservation system described herein.

FIG. 4 illustrates a first user interface 220 displayable on a user mobile device to implement reduced contact fitting room reservations. The user interface 220 allows a user to select one or more items for fitting at a particular retail location.

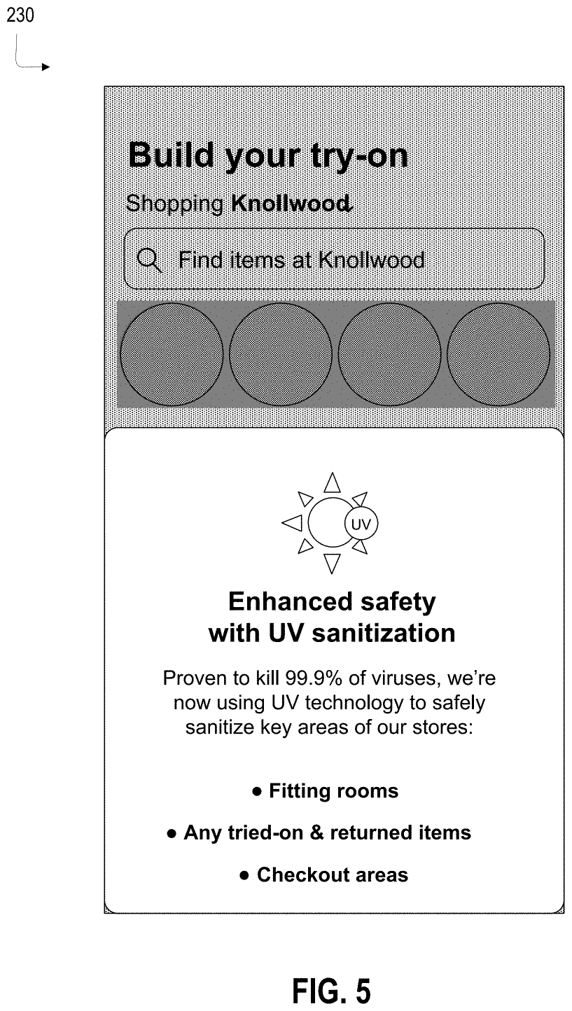

FIG. 5 illustrates a second user interface 230 displayable on a user mobile device to implement reduced contact fitting room reservations. The user interface 230 displays the specific cleaning guidance to notify the user of safety measures in place, thereby ensuring that the user is confident they are able to safely visit the retail location.

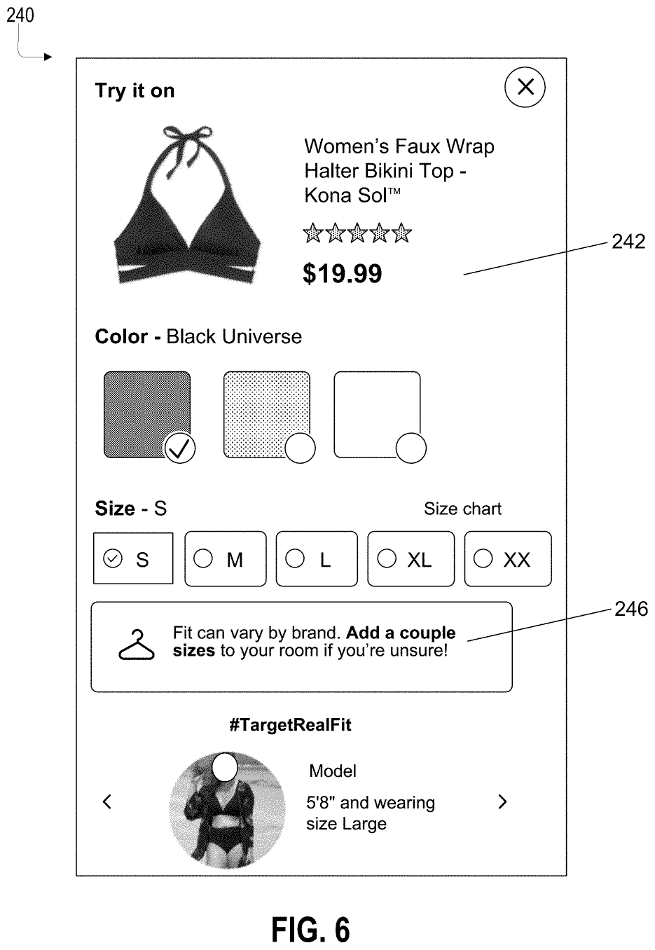

FIG. 6 illustrates a third user interface 240 displayable on a user mobile device to implement reduced contact fitting room reservations. The user interface 240 provides a typical item selection screen in which a user may select an apparel item to be tried on. The user interface 240 presents additional guidance, for example indicating to select multiple items to be tried on, as well as fit guidance.

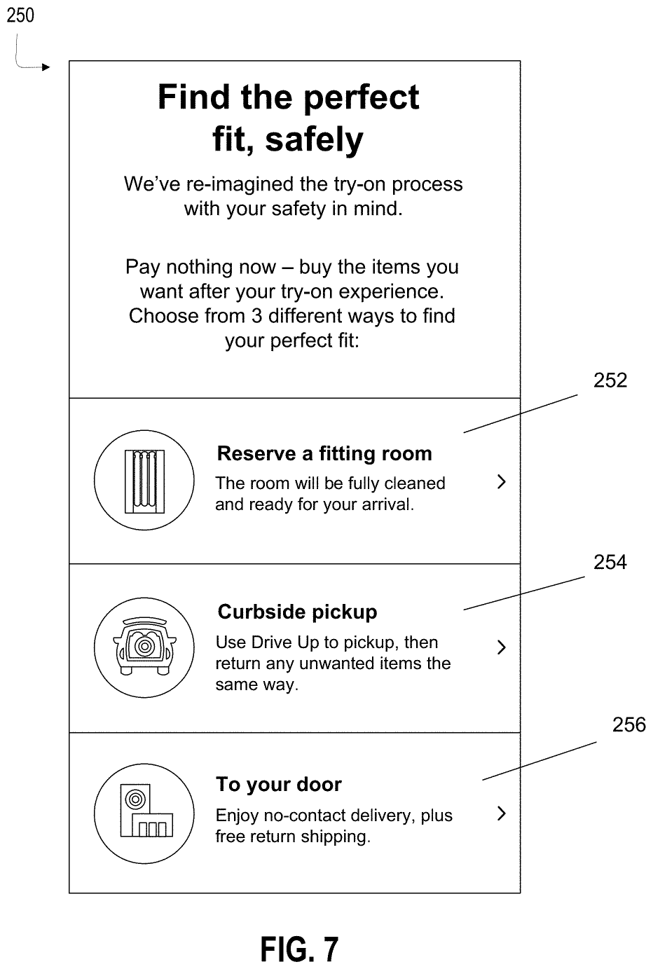

FIG. 7 illustrates a fourth user interface 250 displayable on a user mobile device to implement reduced contact fitting room reservations. The user interface 250 presents three options for the user to obtain the items to be tried on. The three options generally correspond to the alternative apparel fitting flows described above in conjunction with FIG. 2. These include, for example, fitting room reservations, driving up or pickup of items to be tried on, or ship to home.

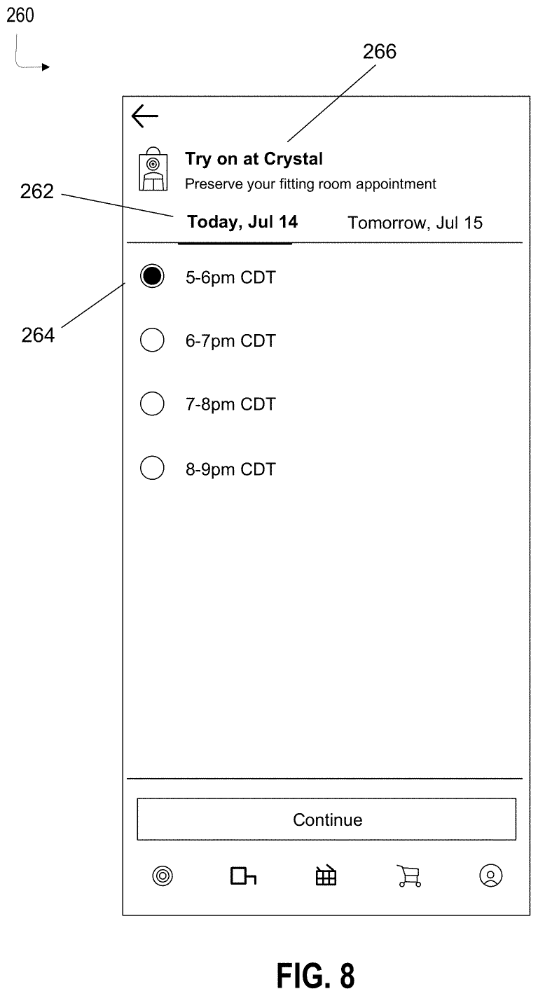

FIG. 8 illustrates a fifth user interface 260 displayable on a user mobile device to implement reduced contact fitting room reservations. The user interface 260 may be displayed to a user selecting fitting room reservations in the user interface 250. In particular the user interface 260 presents a set of available time windows to the user that correspond to available times for reservation of a fitting room at a particular retail location.

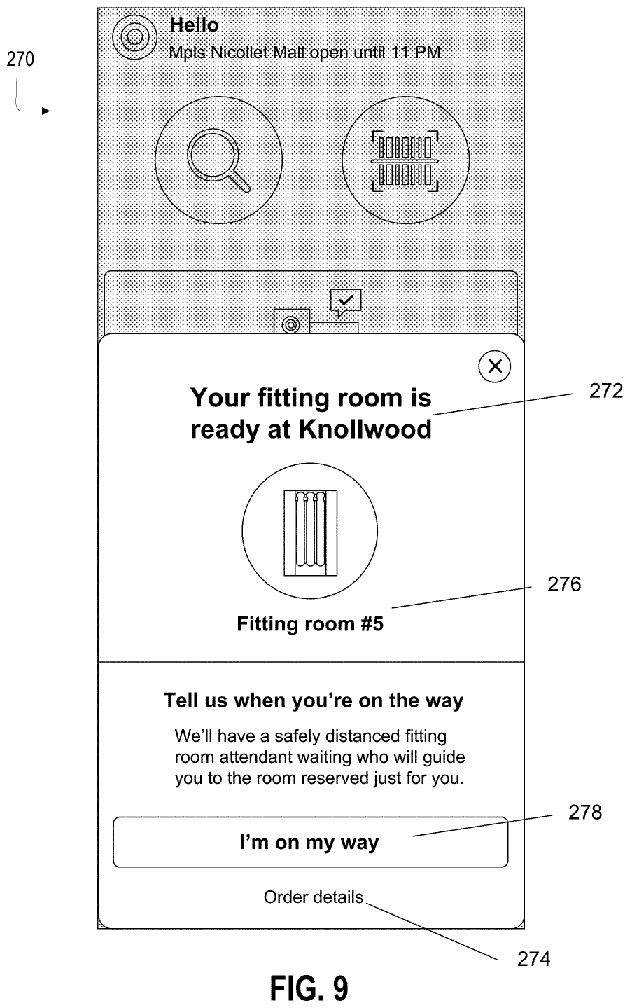

FIG. 9 illustrates a sixth user interface 270 displayable on a user mobile device to implement reduced contact fitting room reservations. The user interface 270 is presentable to the user at a time a fitting room has been prepared at the retail location in accordance with the reservation. The user interface 270 generally includes a notification that is presentable within a user interface generated by a mobile application, and requests that the user send back a notification of when they are on their way to the retail location.

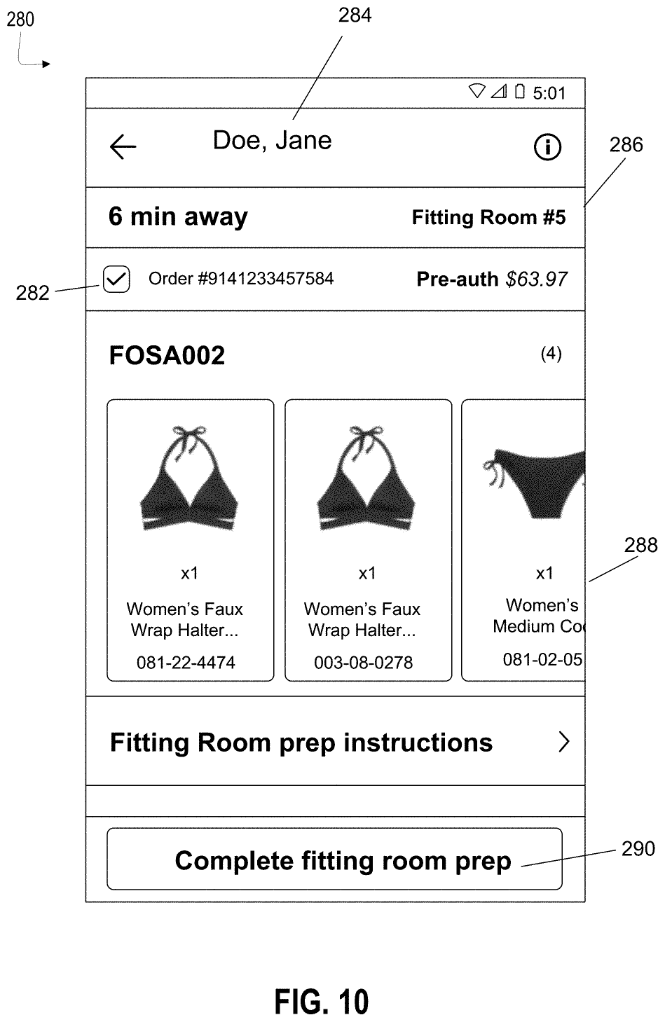

FIG. 10 illustrates a user interface 280 displayable on an employee mobile device to implement reduced contact fitting room reservations. The user interface 1000 generally includes the selection of items made by the user, and is presented to an employee to collect those items and place them in a sanitized fitting room. The fitting room and customer user are both identified in the user interface 280. Upon completion of sanitizing and placing the items in the fitting room, the employee will select a completion option within the user interface 1000, which in turn notifies the customer user that the fitting room is ready for their use, and notifies that customer user of the particular fitting room that they are to use (in this case, Fitting Room #5).

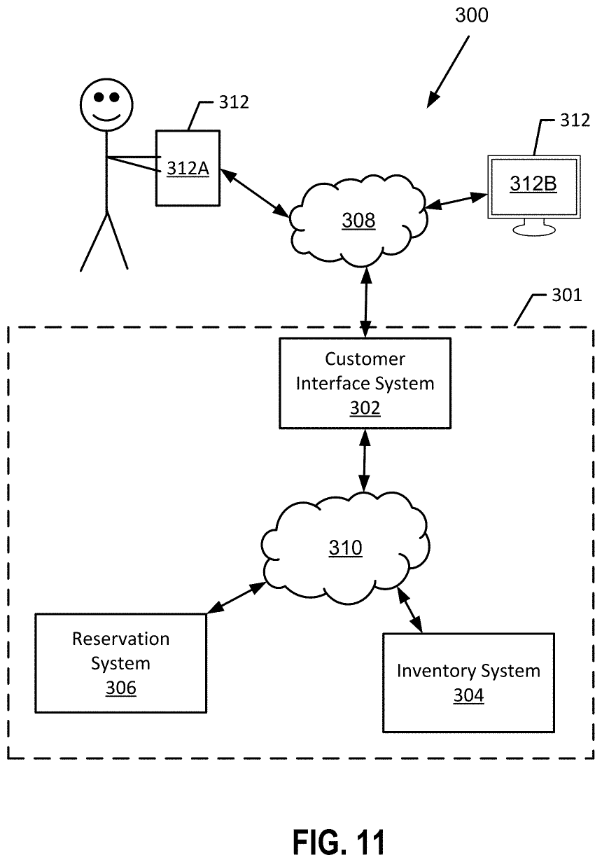

FIG. 11 illustrates an example computing network 300 connecting various computing systems with which aspects of the present disclosure may be implemented. In an example, the network 300 includes one or more user devices 312 (e.g., a mobile device 312A, a home computer 312B, etc.) that connect to a computing environment 301 of a retail provider as part of an online shopping experience. The user devices 312 are connected to the retail provider computing environment 301 via a network 308 (e.g., a cellular network, a Wi-Fi network, etc.). The retail provider computing environment 301 can be physical computing environment, a virtualized computing environment, or a combination thereof.

The retail provider computing environment 301 includes a customer interface system 302, an inventory management system 304, and a reservation system 306. As will be discussed in more detail herein, the customer interface system 302 transmits and receives communication to and from the user devices 312 to provide the online shopping experience. For example, the customer interface system 302 sends the user interfaces 210, 220, 230, 240, 250, 260, 270, 280 shown above and receives user input entered through the user interfaces. Typically, the user devices 312 do not interact directly with the inventory management system 304. In certain examples, the user devices 312 do not interact directly with the reservation system 306.

The customer interface system 302 is connected directly or via a network 310 (e.g., a local network, the Internet, etc.) to the inventory management system 304 and the reservation system 306. The inventory management system 304 keeps track of all items offered for purchase by the retail provider. For example, the inventory management system 304 tracks an item status (e.g., available, backordered, out of stock) for each item. The inventory management system 304 also tracks the locations for the items (e.g., which stores or warehouses stock which items).

The reservation system 306 implements all or part of the process 200 shown in FIG. 2. As will be discussed herein, the reservation system 306 enables a user to reserve fitting room access at a particular retail location during a particular timeframe. In certain implementations, the reservation system 306 also may enable a user to reserve one or more apparel items to be tried on by the user at the particular retail location during the particular timeframe. In certain implementations, the reservation system 306 may schedule sanitizing of the fitting room and collecting of the reserved apparel items prior to the particular timeframe or notify an employee to do the same.

In the example shown, the inventory management system 304 and the reservation system 306 are shown as separate systems. It will be understood, however, that the inventory management system 304 and the reservation system 306 could be implemented using a common computing environment. In other examples, the customer interface system 302 could be implemented in a common computing environment with the reservation system 306 and/or with the inventory management system 304.

Each of the customer interface system 302, the inventory management system 304, and the reservation system 306 of the retail provider computing environment 301 can be implemented as one or more systems or one or more systems having one or more components of the systems 312, 302, 304, 306. In an example, each of the systems 302, 304, 306, 312 can include a respective computing environment. Each of the customer interface system 302, the inventory management system 304, and the reservation system 306 can include memory 328, 392, 462, a communication medium 320, 394, 464, one or more processing units 322, 396, 466, a network interface 324, 398, 468, and an external component interface 326, 400, 470, respectively.

The memory 328, 392, 462 can store various types of data and software. The memory 328, 392, 462 can include a computer readable storage medium. The computer storage medium can be a device or article of manufacture that stores data and/or computer-executable instructions. The memory 328, 392, 462 can include volatile and nonvolatile, transitory and non-transitory, removable and non-removable devices or articles of manufacture implemented in any method or technology for storage of information, such as computer readable instructions, data structures, program modules, or other data. By way of example, and not limitation, computer storage media may include dynamic random access memory (DRAM), double data rate synchronous dynamic random access memory (DDR SDRAM), reduced latency DRAM, DDR2 SDRAM, DDR3 SDRAM, solid state memory, read-only memory (ROM), electrically-erasable programmable ROM, optical discs (e.g., CD-ROMs, DVDs, etc.), magnetic disks (e.g., hard disks, floppy disks, etc.), magnetic tapes, and other types of devices and/or articles of manufacture that store data.

The communication medium 320, 394, 464 can facilitate communication among the components of the computing environment 301. In an example, the communication medium 320, 394, 464 can facilitate communication among the memory 328, 392, 462, the one or more processing units 322, 396, 466, the network interface 324, 398, 468, and the external component interface 326, 400, 470. The communications medium 320, 394, 464 can be implemented in a variety of ways, including but not limited to a PCI bus, a PCI express bus accelerated graphics port (AGP) bus, a serial Advanced Technology Attachment (ATA) interconnect, a parallel ATA interconnect, a Fiber Channel interconnect, a USB bus, a Small Computing system interface (SCSI) interface, or another type of communications medium.

The one or more processing units 322, 396, 466 can include physical or virtual units that selectively execute software instructions. In an example, the one or more processing units 322, 396, 466 can be physical products comprising one or more integrated circuits. The one or more processing units 322, 396, 466 can be implemented as one or more processing cores. In another example, one or more processing units 322, 396, 466 are implemented as one or more separate microprocessors. In yet another example embodiment, the one or more processing units 322, 396, 466 can include an application-specific integrated circuit (ASIC) that provides specific functionality. In yet another example, the one or more processing units 322, 396, 466 provide specific functionality by using an ASIC and by executing computer-executable instructions.

The network interface 324, 398, 468 enables the computing environment 301 to send and receive data from a communication network (e.g., network 308 or network 310). The network interface 324, 398, 468 can be implemented as an Ethernet interface, a token-ring network interface, a fiber optic network interface, a wireless network interface (e.g., WI-FI), or another type of network interface.

The external component interface 326, 400, 470 enables the computing environment 301 to communicate with external devices. For example, the external component interface 326, 400, 470 can be a USB interface, Thunderbolt interface, a Lightning interface, a serial port interface, a parallel port interface, a PS/2 interface, and/or another type of interface that enables the computing environment 301 to communicate with external devices. In various embodiments, the external component interface 326, 400, 470 enables the computing environment 301 to communicate with various external components, such as external storage devices, input devices, speakers, modems, media player docks, other computing devices, scanners, digital cameras, and fingerprint readers.

Although illustrated as being components of a single computing environment 301, the components of the computing environment 301 can be spread across multiple computing environments 301. For example, one or more of instructions or data stored on the memory 328, 392, 462 may be stored partially or entirely in a separate computing environment 301 that is accessed over a network.

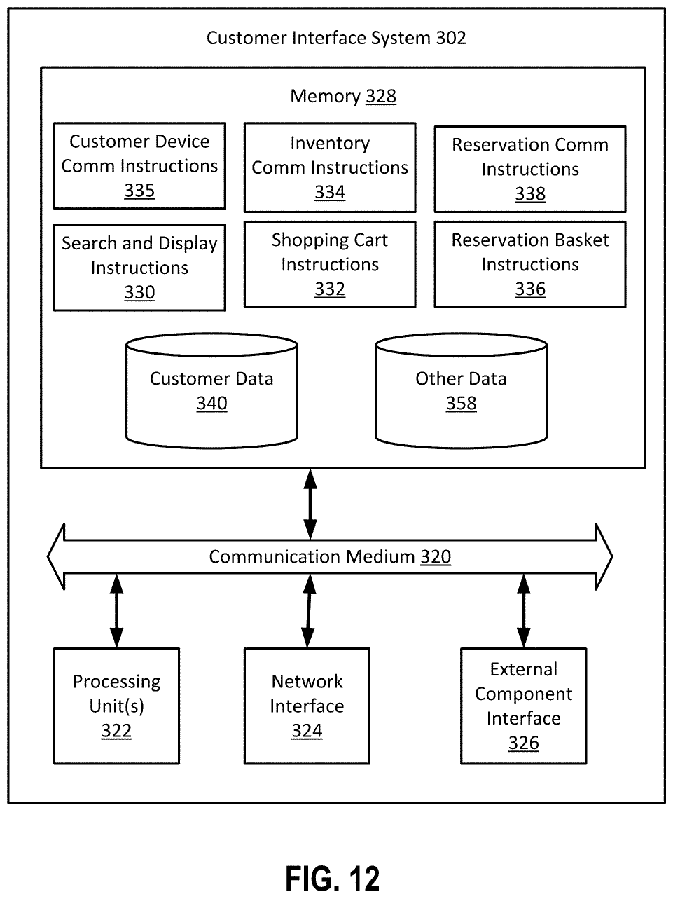

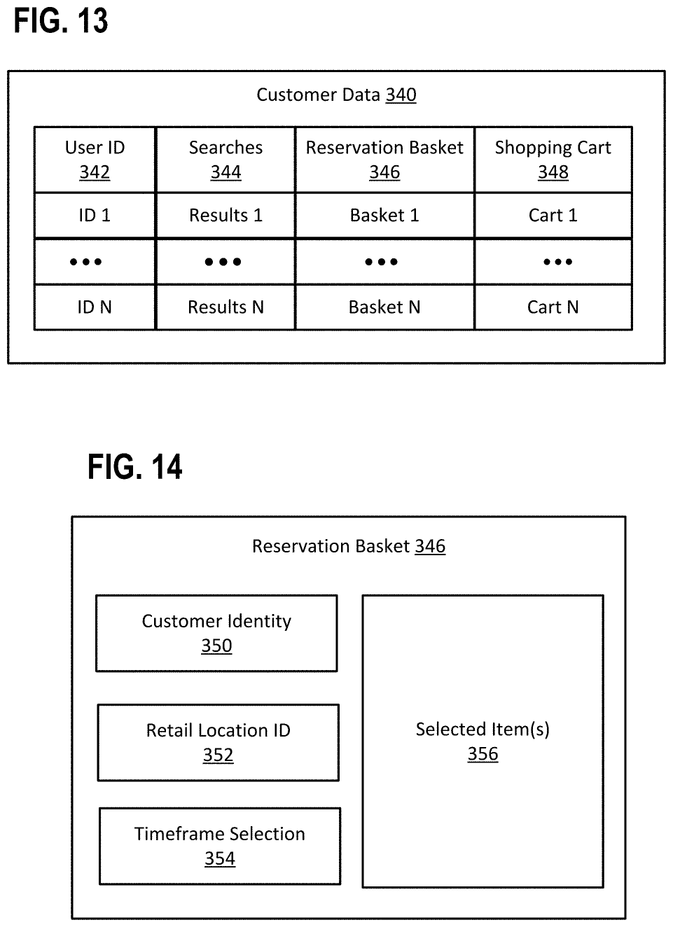

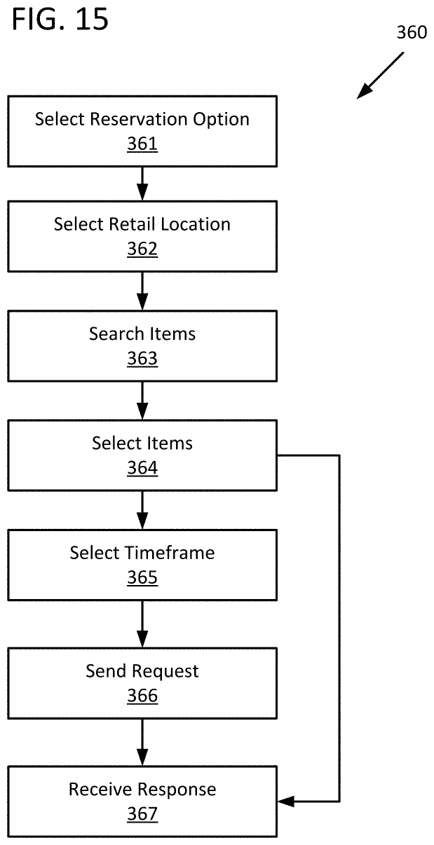

FIGS. 12-14 illustrate an example computing environment and data implementing the customer interface system 302. In memory 328 are stored data and instructions for implementing an online shopping experience for a user. For example, the memory 328 may store instructions 335 for communicating with the customer devices 312, instructions 334 for communicating with the inventory system 304, and instructions 338 for communicating with the reservation system 306. The memory 328 also may store instructions 330 for implementing a requested inventory search and sending the search results back to the requesting user, instructions 332 for implementing a virtual shopping cart, and instructions 336 for implementing a virtual reservation basket 336. For example, the instructions 336 may include instructions for implementing the process 360 shown in FIG. 15. The memory 328 also may store customer data 340 (e.g., as shown in FIG. 13) and/or other data 358.

The customer interface device 302 is configured to interact (e.g., receive search requests, receive check-out (i.e., purchase) requests, receive reservation requests, etc.) with multiple users within a common timeframe. The customer interface device 302 keeps track of which user requests which function. For example, the customer interface device 302 stores customer data 340 including, but not limited to, a user identification 342, searches 344, a virtual reservation basket 346, and a virtual shopping cart 348 (see FIG. 13). Each reservation basket 346 and shopping cart 348 is associated with a particular user identification 342. Some users may have a reservation basket 346 and not a shopping cart 348. Other users may have a shopping cart 348 and not a reservation basket 346.

In some implementations, the user identification 342 includes or is tied to personally identifying information pertaining to the user. For example, the user may be logged into a user account implemented by the retail provider computing environment 301, the user account being tied to personally identifiable information. In other implementations, the user identification 342 includes an IP address or other information that distinctly identifies the user device 312.

In certain implementations, the searches data 344 includes the search criteria provided to the customer interface device 302 from the user device 312. Search criteria may include an indication of a retail department (e.g., apparel, housewares, electronics, media, grocery, etc.) and/or an item type (e.g., shirts, shoes, belts, etc.). In certain implementations, the search criteria may identify a retail location to which to restrict the inventory search. In certain implementations, other item characteristics (e.g., color, size, brand, etc.) may be specified. In certain implementations, the searches data 344 includes the results produced based on the search criteria.

As is known in the art, the virtual shopping cart 348 is a collection of items selected by the user for purchase. The shopping cart 348 keeps track of the selected items while the user browses the search results and/or performs additional searches. The user may access a purchase option via the virtual shopping cart as is known in the art.

As discussed above, the retail provider computing environment 301 enables a user to reserve one or more apparel items to be tried on in person. In certain implementations, the selection of items to be reserved is managed in a virtual reservation basket 346. In certain implementations, the reservation basket 346 is not tied to the virtual shopping cart 348. Adding items to the reservation basket 346 does not automatically add the items to the shopping cart 348. Rather, the reservation basket 346 provides access to a reservation request option instead of a purchase option. The reservation basket 346 keeps track of the selected items while the user continues to browse search results or performs additional searching. In certain examples, the reservation basket 346 and virtual shopping cart may be configured to enable a user to move items therebetween.

FIG. 14 illustrates information stored by the virtual reservation basket 346. One or more selected items 356 (e.g., an item identification of each selected item) is stored in the reservation basket 346. In certain implementations, the reservation basket 346 includes a retail location identifier 352 identifying a particular retail location at which the user wants to reserve a fitting room. In certain implementations, the reservation basket 346 includes customer identity data 350 that identifies the user sufficient to enable a retail provider employee to match the user to the reservation when the user arrives. The customer identity data 350 may include personally identifiable information (e.g., first and last name), personal information (e.g., first name only), or an assigned unique identifier (e.g., a generated and assigned reservation number). In some implementations, the reservation basket 346 includes a timeframe selection 354 identifying a timeframe for which the user wants to reserve the fitting room at the particular retail location. In other implementations, the reservation basket 346 does not include the timeframe selection 354.

As shown in FIGS. 3-10, the customer interface device 302 may provide one or more user interfaces 210, 212, 214, 216, 218, 220, 230, 240, 250, 20, 270, 280 to a user device 312 that enable a user of the user device 312 to build a reservation basket 346. FIG. 15 walks through the user's experience for reserving apparel items as implemented through one example process 360. At operation 361, the user selects an option to begin building a reservation basket.

For example, the user may view the user interface 250 provided in FIG. 7 and select a reserve option 252. In some implementations, the reserve option 252 allows a user to reserve a fitting room at a specified time (e.g., a half-hour time slot, an hour time slot, etc.) including reserving specific items to be tried on in the fitting room. In certain examples, the reserve option 252 assigns a designated fitting room to the reservation. In other implementations, the reserve option 252 allows a user to reserve items to be tried on within a predetermined time period (e.g., four hours, eight hours, twelve hours, twenty-four hours, etc.), but does not reserve a specific timeslot or a specific fitting room. Alternatively, the user may start a virtual shopping cart by selecting a pickup option 254 or a shipping option 256. In some examples, the user interface 250 may be displayed to the user before the user searches for items. In other examples, the user interface 250 is displayed to the user after the selects an item.

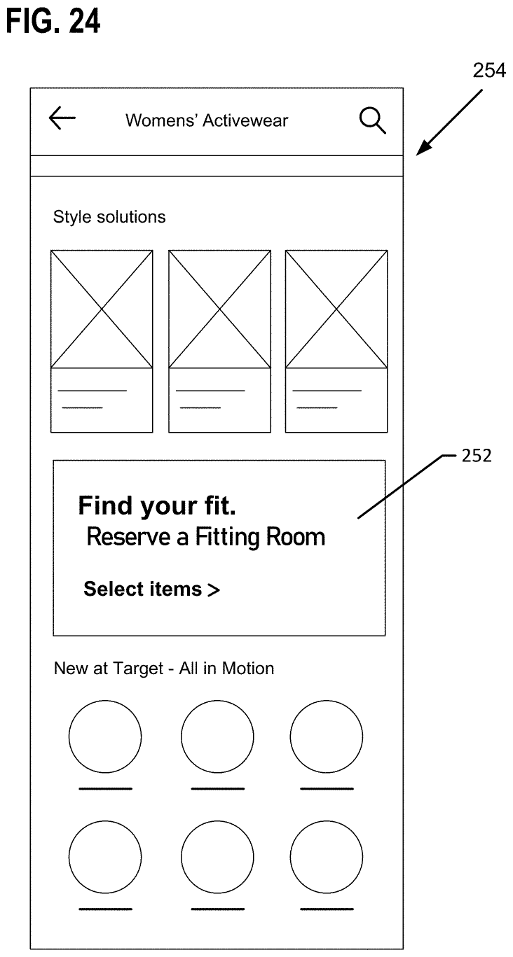

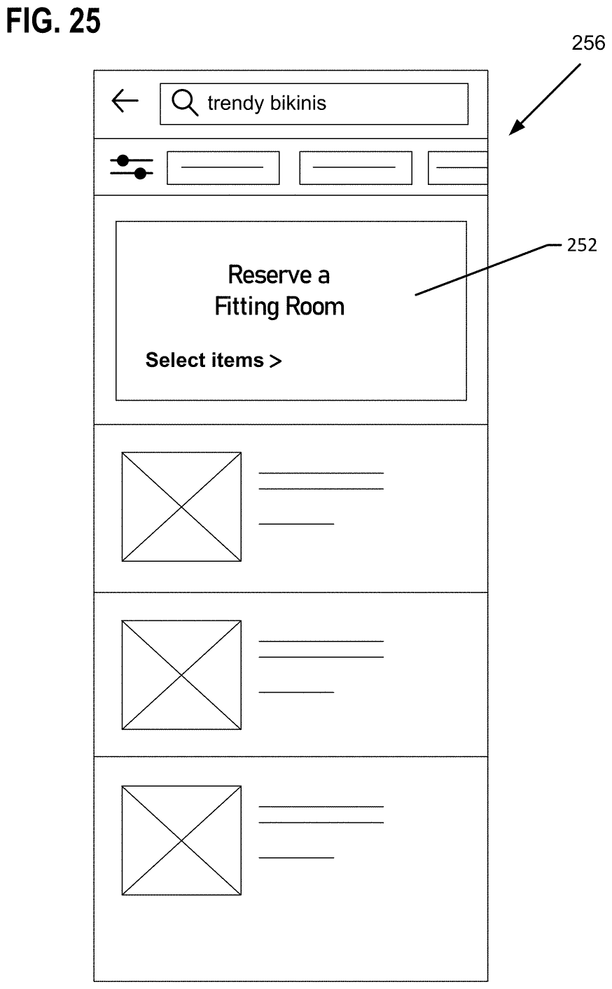

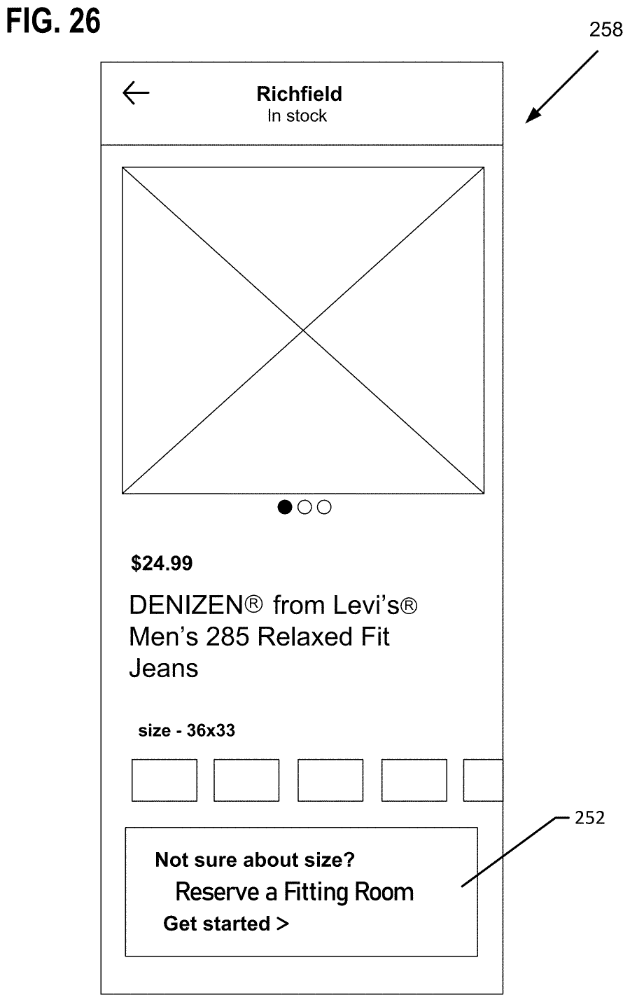

FIG. 24 illustrates another example user interface 254 providing a reserve option 252. The user interface 254 displays a category of apparel items (e.g., shirts, pants, dresses, etc.). In the depicted example, the user interface 254 displays apparel items associated with the department of Women's Activewear. FIG. 25 illustrates another example user interface 256 providing a reserve option 252. The user interface 256 displays search results based on criteria supplied by the user. In the depicted example, the search criteria is “trendy bikinis.” FIG. 26 illustrates another example user interface 258 providing a reserve option 252. The user interface 258 displays information on a particular apparel item (e.g., after the apparel item is selected by the user). The information can include the characteristics of the item (e.g., brand, description, available sizes, available colors, price, picture, etc.). The information also can include whether the item is available at a selected retail provider location.

At operation 362, the user identifies a retail location at which the user wishes to reserve a fitting room. For example, the user may view the user interface 220 illustrated in FIG. 4 and select particular location from a predetermined list 222. In an example, the user selects the location from a drop down menu. In another example, the user performs a search of retail locations near a particular zip code, cite and state, GPS location, etc. and selects one of the search results.

At operation 363, the user provides search criteria and reviews produced search results for apparel items. In some examples, only items available at the selected retail location appear in the search results. In other examples, all items meeting the provided search criteria are presented to the user. Along with the search results, the user interface may provide a way to select items to be added to the reservation basket 346.

For example, the user may view the user interface 240 of FIG. 6. The user interface 240 includes information 242 pertaining to the item being displayed. For example, the item information 242 may include characteristics such as brand, item description, and price. In certain implementations, the user interface 240 also includes selectable options such as size and/or color. In the example shown, the user interface 240 provides an option 246 to add the displayed item to the reservation basket. The user may select the option 246 in operation 364 or may choose to continue browsing the search results.

In operation 365, when the user has chosen the items to be tried on, the user elects to continue with the reservation process including choosing a timeframe for the reservation. The user device 312 sends the selected items and selected retail location to the customer interface system 302, which responds with a list of timeframes during which a fitting room is available at the selected retail provider location. In certain examples, the reservation request includes user identity data (e.g., a name of the user).

In some implementations, a user may schedule a specific time at which a fitting room will be available. In such implementations, the reservation process 360 proceeds to operation 366. The user reviews the timeframes and selects one of the timeframe options at operation 366. For example, the user may view the user interface 260 of FIG. 8. In the depicted example, the user selects a date 262 (e.g., today, a calendar date, etc.) on which the user wishes to reserve the fitting room. The user also selects a time 264 (e.g., a specific time, a pre-determined time slot, etc.) on the selected date 262. In certain implementations, only available dates 262 and/or time slots 264 at the retail location are displayed for selection. In certain implementations, the user interface 260 provides an indication 266 of the selected retail location. In certain examples, the user interface 260 may enable the user to change the selected retail location.

In other implementations, however, the selected items are automatically reserved for a predetermined period of time (e.g., 2, hours, 4 hours, 8 hours, 12 hours, 24 hours, 48 hours, 72 hours). Accordingly, instead of being presented with available time slots, the user is instead informed of the time period during which the items will be held. The user also may be provided with instructions to check-in with a fitting room attendant upon arrival at the retail location at any point during the predetermined period of time. In such implementations, the reservation process 360 proceeds to operation 367.

In operation 367, the user receives a reservation confirmation from the customer interface system 302. For example, the user may view the user interface 270 of FIG. 9. The reservation confirmation may include an indication 272 of the retail provider location and the order details 274 (e.g., the reserved timeframe, the reserved items, etc.). In certain examples, the reservation confirmation includes a reservation identifier (e.g., a reservation number, a customer number, etc.) by which the user can be matched to the reservation upon arrival at the retail provider location. For example, the reservation identifier may be provided in order details. In some examples, the reservation confirmation may include an identifier 276 for a specific fitting room. In other examples, the reservation confirmation may include instructions to check-in with a fitting room attendant upon arrival. In certain examples, the reservation confirmation may include a selectable option 278 to indicate the user is soon to arrive at the reservation.

In other implementations of the process 360, the user may search for items before selecting a reservation option. In certain implementations, the user may select a retail location before selecting a reservation option and/or after searching for items. In some implementations, the user is only presented with items available for reservation at the selected location if a location is selected prior to the search. In other implementations, the user is also presented with items available at retail locations within a predetermined distance from the selected retail location. In still other implementations, the user is presented with items available for purchase regardless of whether the item is available for reservation.

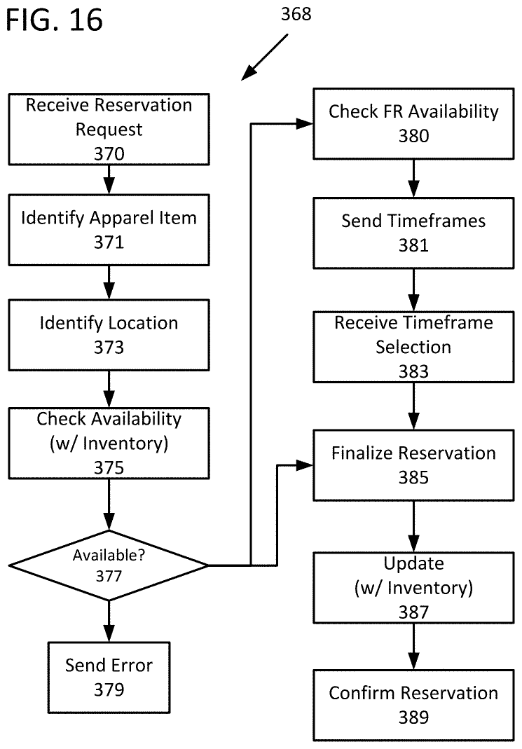

FIG. 16 illustrates an example flow for a process 368 by which the customer interface system 302 may enable a user to reserve a fitting room. In operation 370, the customer interface system 302 receives a request for available timeframes from a user device 312. For example, the customer interface system 302 may receive the request via the network interface 324. As discussed above, the request for available timeframes includes an indication 352 of a selected retail location and an indication 356 of one or more items selected for reservation.

In operation 371, the customer interface device 302 identifies the apparel item(s) (i.e., parses the item indicator 356) included in the request. In operation 373, the customer interface device 302 identifies the indicated retail location (i.e., parses the location indicator 352) included in the request. In operation 375, the customer interface device 302 sends a request to the inventory management system 304 to determine whether the selected items are available at the selected retail location. For example, the customer interface device 302 sends a request to the inventory management system 304 to check a status and location of the selected item.

The customer interface device 302 parses a response from the inventory management system 304 at operation 377 and determine whether the items are available at the selected retail location. If the items are not available, then the customer interface device 302 sends an error message to the customer device 312 at operation 379. In various examples, the error message may indicate which items are not available or a different retail location at which the selected items would be available.

If available, then the customer interface device 302 sends a reservation request to the reservation system 306 at operation 380. In some implementations, the users are provided with available fitting rooms (e.g., are assigned fitting rooms by a fitting room attendant, select their own fitting rooms, etc.) upon arriving at the retail location. In such implementations, the process 368 proceeds directly to operation 385

In other implementations, the reservation system 306 assigns a designated fitting room to each user making a reservation. In such cases, the process 368 proceeds to operation 380 to determine when a fitting room would be available at the selected retail location. The customer interface device 302 parses a response from the reservation system 306 at operation 381 to determine a set of timeframes at which a fitting room is available and sends the available timeframes to the customer device 312. At operation 383, the customer interface device 302 receives a selected timeframe 383 from the customer device 312. The process 368 then proceeds to finalize operation 385.

In finalize operation 385, the customer interface device 302 sends a message to the reservation system 306 to finalize the reservation. In operation 387, the customer interface device 302 sends a message to the inventory management system 304 to update the status of the selected items. In operation 389, the customer interface device 302 sends a reservation confirmation to the customer device 312. The reservation confirmation indicates the retail location, timeframe, and items reserved. In certain examples, the reservation confirmation may include a reservation identification number or other identifier by which the user can be matched to the reservation when the user arrives at the retail location.

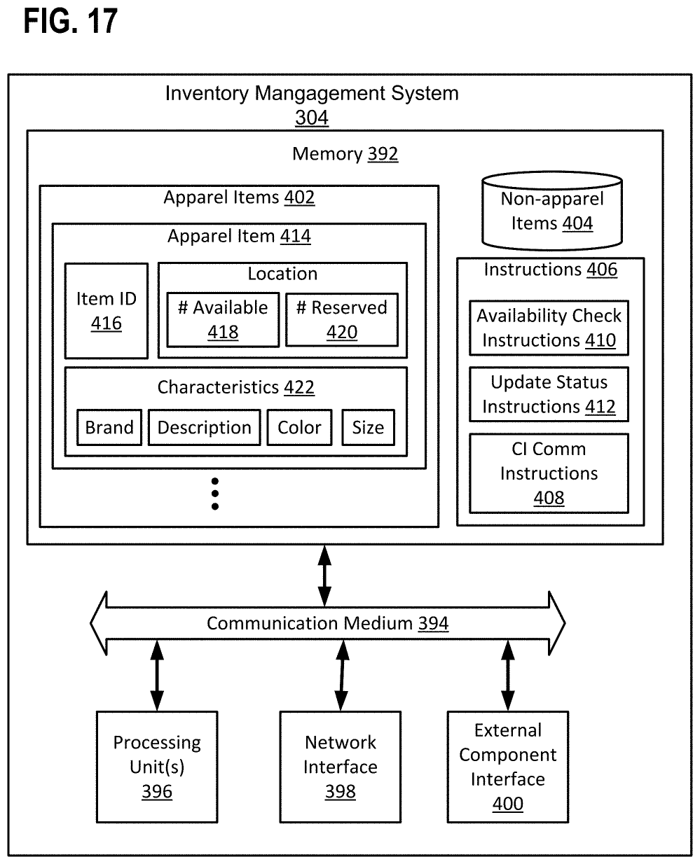

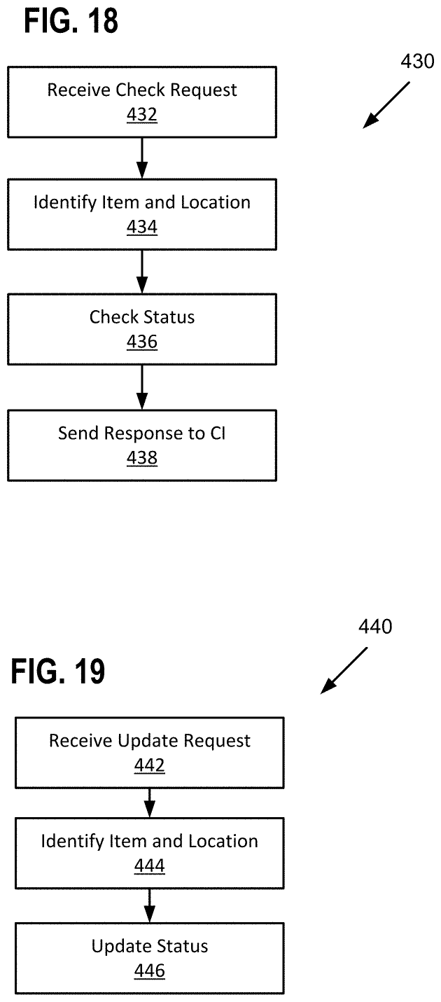

FIG. 17 illustrates an example inventory management system 304 suitable for use with the customer interface system 302 shown above with respect to FIG. 12. FIGS. 18 and 19 illustrate example processes (i.e., a check availability process and an update status process) implemented by the inventory management system 304 in response to requests received from the customer interface system 302.

In memory 392 are stored data 402, 404 and instructions 406 for tracking inventory of items offered for sale by the retail provider. For example, the memory 392 may store instructions 408 for communicating with the customer interface system 302, instructions 410 for checking the availability of one or more items, and instructions 412 for updating a status of one or more items. In certain examples, the instructions 410 include instructions for implementing the process 430 shown in FIG. 18 and the instructions 412 include instructions for implementing the process 440 shown in FIG. 19.

In the depicted example, the stored data includes data pertaining to apparel items 402 and data pertaining to non-apparel items 404. In certain examples, the data 402, 404 is not stored separately. For ease in viewing, however, the depicted view has been simplified to show the apparel item data separately.

Under apparel items 402, the inventory management device 304 tracks the apparel items through item identifiers 416. In some examples, each item identifier uniquely identifies an individual item. In other examples, each item identifier uniquely identifies a type of item (e.g., an item having a particular set of characteristics such as brand, description, color, and size). In such examples, each item identifier 416 also includes an identifier 418 of the number of available items. In some examples, the availability identifier 418 is tied to a specific retail location. For example, each item identifier 418 may be associated with a plurality of retail locations at which the item is available and have a separate availability identifier 418 for each location.

In certain examples, each item identifier 416 also may include an identifier 420 indicating the number of items reserved (e.g., at a particular location). In certain implementations, once a user reserves a particular item to be tried on, the item is no longer considered available. However, not all reserved items will be purchased. Accordingly, it may be helpful to separately track the number of reserved items to gain a better understanding of inventory status at a particular store.

In other implementations, each individual item (not just item type) is uniquely identified by the item identifier. In such implementations, each item identifier may have a status of available, reserved, back ordered, and/or sold out. In such implementations, each item identifier also may list a location of the item (e.g., if available, reserved, or back ordered).

FIG. 18 illustrates a check process 430 implemented by the inventory management system 304 in response to the request operation 375 performed by the customer interface system 302 in FIG. 16. In operation 432, the inventory management system 304 receives the request from the customer interface system 302 to check availability of one or more items at a particular retail location. In operation 434, the inventor management system 304 determines the selected items (e.g. parses the request to identify item identifiers of the requested items) and determines the selected location (e.g., parses the request to identify the location identifier).

In operation 436, the inventory management system 304 checks whether each of the selected items is available at the selected location. For example, the inventory management system 304 may determine whether the number available indication 418 for the item matching the item identifier under the requested location identifier is greater than one. In other examples, the inventory management system 304 may determine whether the selected location has an item with the appropriate item identification type marked available

In certain implementations, the inventory management system 304 may check whether any of the requested item or items are indicated as reserved.

In operation 438, the inventory management system 304 sends a response to the customer interface device 302. If a matching item or items are determined to be available at operation 438, then the response confirms the availability of the item at the retail location. If one or more of the items are determined at operation 436 to be not available (e.g., if the number available is zero), then the response identifies the item or items that are not available.

In other implementations, the check process 430 may be implemented by the inventory management system 304 in response to a request received from the reservation system 306.

FIG. 19 illustrates an update process 440 implemented by the inventory management system 304 in response to the update operation 387 performed by the customer interface system 302 in FIG. 16. At operation 442, the inventory management system 304 receives the update request from the customer interface system 302. The update request may include an item identifier to identify a particular item or item type. The update request also may include a location identifier to identify a particular retail location. The identified item (or item type) and the identified location are parsed at operation 444.

At operation 446, the status of the item or item type is updated to reflect the reservation. For example, the identifier 418 indicating the number of items available may be decremented. In certain examples, the identifier 420 indicating the number of items reserved may be incremented. In other examples, the status of a particular item may be changed from “available” to “reserved” in the apparel item memory 402.

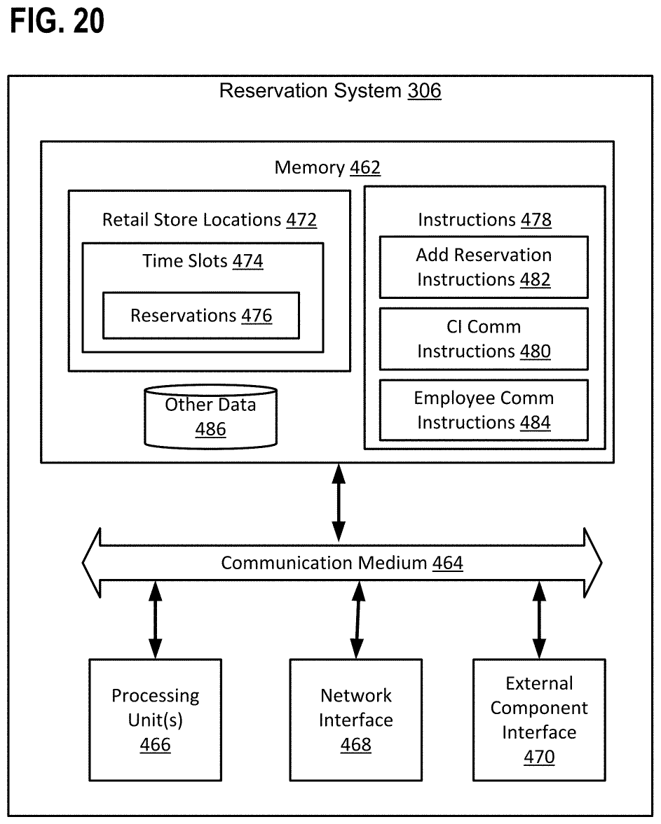

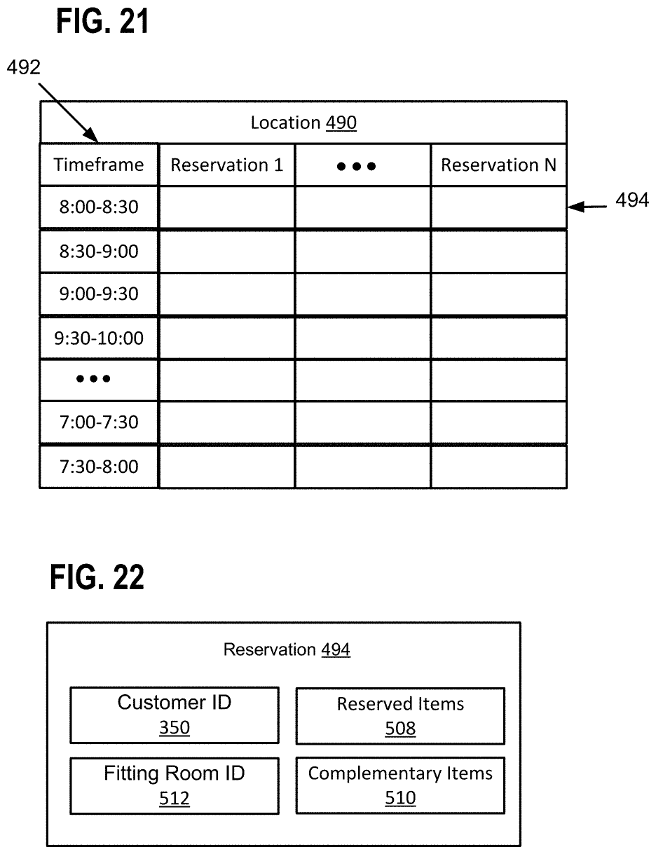

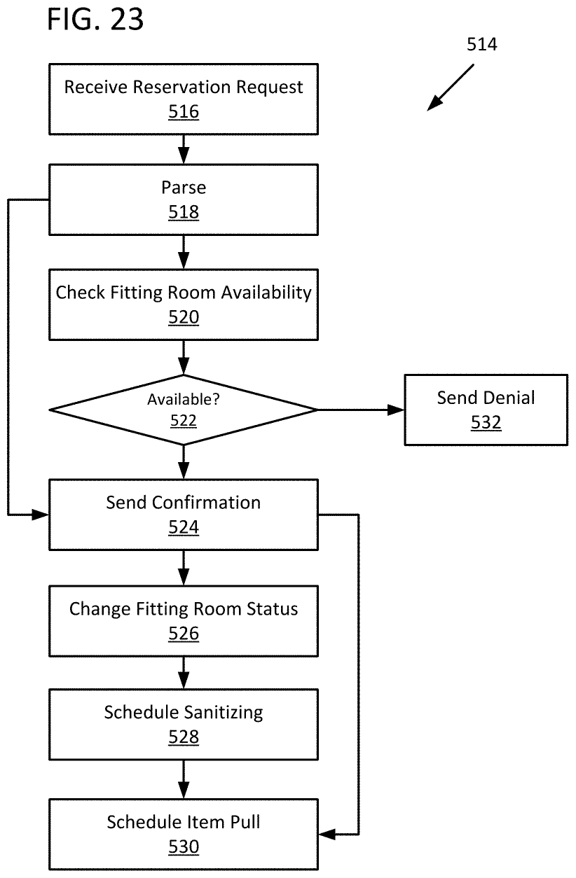

FIG. 20 illustrates an example reservation system 306 suitable for use with the customer interface system 302 shown above with respect to FIG. 12. The memory 462 of the reservation system 306 stores instructions 478 (e.g., instructions 480 to communicate with the customer interface device 302, instructions 482 to add a reservation to the schedule, etc.). In certain examples, the reservation system 306 stores reservation data 476, scheduling data 474 for each retail store location 472, and/or other data 486. An example implementation of the scheduling data 474 is illustrated in FIG. 21. In other implementations, however, the reservation data 476 may be stored without a fitting room schedule. In still other implementations, the scheduling data 474 may indicate a time period during which each reservation 476 is active or a time at which each reservation 476 expires. The add reservation instructions 482 may include instructions to implement the example process shown in FIG. 23.

FIG. 21 illustrate example scheduling data 472 for a particular retail provider location 490. In certain implementations, the scheduling data 472 includes a list of time slots 492 and one or more reservation entries 494 for each time slot. In the depicted example, the time slots 492 are organized in half-hour increments. In other examples, the time slots 492 can be longer or shorter. In certain examples, the length of a time slot 492 may be chosen by the user. The number of reservation entries 494 per time slot 492 is limited by the available number of fitting rooms at the retail location. In some examples, a reservation entry 494 is added to a time slot 492 when the reservation is made. In other examples, each time slot 492 is pre-populated with a maximum number of reservation entries and the reservation data is added to one of the reservation entries 494 when the reservation is made.

FIG. 22 illustrates an example reservation entry 494 that can be associated with a time slot 492 at a particular retail location 490. The reservation entry 494 is populated based on the reservation basket 346. Accordingly, the reservation entry 494 includes the customer ID 350 by which the user can be matched to the reservation entry 494 when the user arrives at the retail provider location. As discussed above, the customer ID 350 can include personally identifiable information (e.g., a full name), personal information (e.g., a first name, a nickname, etc.), or assigned information (e.g., a reservation number provided in the reservation confirmation message).

The reservation entry 494 also includes a list 508 of apparel items reserved by the user. Typically, the list 508 includes the selected apparel items 356 from the reservation basket. In certain examples, the list 508, 356 may differ if any of the selected items 356 were unavailable at the particular retail provider location. In certain implementations, the reservation entry 494 also may include complementary items 510 selected by the retail provider to enhance the fitting room experience. The complementary items 510 may include apparel items that match with the reserved items to complete an outfit (e.g., accessory items such as belts, scarves, shoes, etc.), or apparel items assisting in determining fit (e.g., adjacent sizes, shoes with different heel heights, etc.).

In some implementations, the reservation system 306 assigns the user to a particular fitting room at the retail provider location. In such implementations, the reservation entry 494 includes a fitting room identifier 512 (e.g., fitting room number) indicating the fitting room assigned to the user. Assigning a particular fitting room may enable an employee to ensure the fitting room is cleaned (e.g., sanitized) and the reserved and any complementary items 508, 510 are placed in the fitting room before the user arrives. In certain examples, the fitting room identifier 512 may be included on the reservation confirmation message so that the user can proceed to the fitting room upon reaching the retail provider. In other implementations, the reservation system 306 only tracks the number of available fitting rooms and allows an employee to assign a fitting room when the user arrives. Waiting to assign a fitting room may provide more flexibility to users who want to use the fitting room for more than their scheduled time. In still other implementations, the reservation system 306 does not track fitting room availability. Instead, a user waits for the next available fitting room upon checking-in with a fitting room attendant.

FIG. 23 illustrates an example process 514 for adding/populating a reservation entry 494 to the scheduling data 472. The process 514 is implemented by the reservation system 306 in response to a reservation request received from the customer interface system 302 at operation 516. The reservation request includes a retail provider location identifier 352, which is parsed at operation 518. In certain implementations, the reservation request also includes a timeframe identifier 354, which is parsed at operation 518. In some examples, the timeframe identifier indicates a selected timeslot. In other examples, the timeframe identifier indicates a timeframe during which the reservation will be active.

In some implementations, the reservation system 306 does not ensure fitting room availability for a specific timeslot. In such implementations, the process 514 proceeds to confirmation operation 524. In other implementations, the reservation system 306 enables users to designate a specific timeslot and ensures fitting room availability for the timeslot.

For example, at operation 520, the reservation system 306 determine whether any fitting rooms are available at the identified retail provider location during the identified timeframe. In some examples, the reservation system 306 may store a counter for each retail location for each timeframe indicating how many fitting rooms remain available. In such examples, the reservation system 306 checks the counter associated with the requested retail provider location and timeframe. In other examples, the reservation system 306 determines whether any of the reservation entries stored under the requested timeframe for the requested retail provider location remain unpopulated. If the reservation system 306 determines at module 522 that a fitting room is not available for the requested timeframe at the requested retail provider location, then the reservation system 306 sends a denial to the customer interface system 302 at operation 532.

If the reservation system 306 determines at module 522 that a fitting room is available for the requested timeframe at the requested retail provider location, then the reservation system 306 sends a reservation confirmation message to the customer interface device at operation 524. The reservation confirmation message may include a reservation number or other identifier to match the user with the reservation. The reservation confirmation message may include the retail provider location and timeframe actually reserved. In certain examples, the reservation confirmation message also may include an identifier for an assigned fitting room.

In some implementations, the reservation system 306 does not assign designated fitting rooms to the reservations. In such implementations, the process 514 proceeds directly to operation 530. In other implementations, the reservation system 306 assigns a specific fitting room to each reservation. For example, at operation 526, the reservation system 306 updates the availability status of the fitting rooms at the retail provider location for the timeframe. For example, the reservation system 306 may decrement a counter of available fitting rooms. In another example, the reservation system 306 may populate a reservation entry under the relevant timeslot.

At operation 528, the reservation system 306 may schedule sanitizing of the assigned fitting room so that the fitting room may be cleaned before the user arrives. In certain examples, the reservation system 306 updates a cleaning schedule accessible to employees at the retail provider location. In certain examples, the reservation system 306 sends a message to employees at the retail provider location to clean the assigned fitting room.

At operation 530, the reservation system 306 sends the list 508 of reserved items to employees of the retail provider location to that the reserved apparel items can be pulled off the shelves or from the back room prior to the user's arrival. In some implementations, the reservation system 306 also sends a list of complementary items 510 automatically generated based on the reserved items. In other implementations, an employee at the retail provider location chooses which complementary items 510, if any, to include.

In certain implementations, the reservation system 306 also may send a check request to the inventory management system 304 based on reservation information received from the reservation request in operation 516. In such implementations, the reservation system 306 proceeds to operation 520 only if the requested item is indicated as available and sends a denial at operation 532 if the requested item is not available.

For example, FIG. 10 illustrates an example user interface 280 displayable to an employee of the retail provider location. The user interface 280 includes an identifier 282 for the reservation, optionally an identifier 284 for the customer, optionally an identifier 286 for a particular fitting room assigned to the customer, and a list 288 of reserved items to be collected and placed in a fitting room (e.g., the assigned fitting room). The user interface 280 also may request confirmation (e.g., see button 290) that the assigned fitting room (or an available fitting room) has been prepared (e.g., sanitized, stocked with the requested items, and optionally stocked with complementary items).

After the user arrives and utilizes the reserved fitting room, the user can then choose to purchase one or more of the reserved items. In some examples, the user purchases the items at a register (e.g., a staffed register, a “self-checkout” register, a kiosk, etc.). In other examples, the user may purchase one or more of the reserved items through the customer device 312. For example, the user may transfer the reserved items the user wishes to purchase from the reservation basket to the virtual shopping cart and proceed with checkout. Such an option may allow the user to complete the shopping experience without requiring contact with an employee.

In certain implementations, the inventory management system 304 automatically removes the reservation status from reserved items after the reserved timeframe has expired. In certain examples, the reservation status is removed a set period of time (e.g., an hour, a day, etc.) after the reserved timeframe has expired. In certain implementations, an employee of the retail provider location can send a request for the inventory management system to remove the reservation status from the item (e.g., if the employee assists the user in purchasing the item or if the employee begins the process to return the item to the shelf).

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., portions, components, etc.) described with respect to the figures herein are not intended to limit the systems and methods to the particular aspects described. Accordingly, additional configurations can be used to practice the methods and systems herein and/or some aspects described can be excluded without departing from the methods and systems disclosed herein.

Similarly, where steps of a process are disclosed, those steps are described for purposes of illustrating the present methods and systems and are not intended to limit the disclosure to a particular sequence of steps. For example, the steps can be performed in differing order, two or more steps can be performed concurrently, additional steps can be performed, and disclosed steps can be excluded without departing from the present disclosure.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

### Aspects of the Disclosure

Aspect 1. A method of implementing electronic shopping on a customer device external of a retail store, the method comprising: receiving from the customer device a reservation request for the at least one apparel item, the reservation request including a location identifier and an item identifier for the at least one apparel item; determining that the at least one apparel item is or can be available at a retail location indicated by the location identifier; determining available timeframes during which a fitting room is available at the retail location indicated by the location identifier; sending at least some of the available timeframes to the customer device; receiving a timeframe selection from the customer device; finalizing a reservation for the at least one apparel item at the retail location indicated by the location identifier at a timeframe indicated by the timeframe selection; and sending to the customer device a reservation confirmation.

Aspect 2. The method of Aspect 1, wherein determining that the at least one apparel item is or can be available at the retail location includes: sending an availability check request to an inventory management system, the availability check request including the location identifier and an item identifier for the at least one apparel item; and receiving confirmation from the inventory management system that the at least one apparel item is available at the retail location indicated by the location identifier.

Aspect 3. The method of Aspect 2, wherein finalizing the reservation includes sending an update to the inventory management system indicating that the at least one apparel item is reserved at the retail location.

Aspect 4. The method of Aspect 1, wherein determining available timeframes comprises: sending a reservation inquiry to a reservation system, the reservation inquiry including the location identifier; and receiving the available timeframes from the reservation system.

Aspect 5. The method of Aspect 4, wherein finalizing the reservation includes sending a confirmation to a reservation system indicating that the at least one apparel item is reserved at the retail location.

Aspect 6. A method of reserving a fitting room for a user upon request, the method comprising: receiving from a customer interface system a reservation inquiry including a location identifier; determining fitting room availability at a retail location indicated by the location identifier to obtain a list of available timeframes; sending the list of available timeframes to the customer interface system; receiving a selection of the of the available timeframes from the list, the selection indicating a selected timeframe; reserving a fitting room at the retail location indicated by the location identifier for the selected timeframe, wherein reserving the fitting room includes updating the fitting room availability at the retail location indicated by the location identifier at the selected timeframe; scheduling an item pull to collect one or more apparel items and place the collected apparel items in the fitting room by the selected timeframe; and sending a confirmation to the customer interface system.

Aspect 7. The method of Aspect 6, further comprising scheduling a sanitizing of the fitting room by the selected timeframe.

Aspect 8. The method of Aspect 6, wherein reserving the fitting room includes assigning a particular fitting room; and wherein the confirmation includes an identifier of the particular fitting room assigned.

Aspect 9. The method of Aspect 6, wherein the fitting room is any fitting room determined to be available at the retail location indicated by the location identifier at or near the selected timeframe.

Aspect 10. The method of Aspect 6, wherein updating the fitting room availability includes decrementing an availability counter.

Aspect 11. The method of Aspect 6, wherein updating the fitting room availability includes populating a reservation entry associated with the selected timeframe.

Aspect 12. The method of claim 11, wherein the reservation inquiry or the selection includes a customer identifier; and wherein updating the fitting room availability associates the customer identifier with the fitting room.

Aspect 13. The method of claim 6, wherein scheduling the item pull includes sending a message to an employee of the retail location to collect the one or more apparel items, the one or more apparel items including an apparel item indicated by an apparel item identifier provided to the reservation system in the reservation inquiry or the timeframe selection.

Aspect 14. The method of claim 13, wherein the one or more apparel items include a complementary item automatically generated by the reservation system or the inventory management system.

Aspect 15. A retail location computing environment comprising: an inventory management system configured to track availability of a plurality of apparel items at a retail location; a reservation system configured to reserve a fitting room at the retail location; and a customer interface system configured to communicate with a plurality of customer devices, the inventory management system, and the reservation system, the customer interface system being configured to interface between one of the customer devices and the reservation system to enable a user of the customer device to reserve a fitting room at the retail location.

Aspect 16. The retail location computing environment of Aspect 15, wherein the customer interface system is configured to communicate with the inventory management system to update an availability status of an apparel item at the retail location when the apparel item is reserved by the customer device.

Aspect 17. The retail location computing environment of Aspect 15, wherein the customer interface system checks availability of the apparel item with the inventory management system before interfacing with the reservation system.

Aspect 18. The retail location computing environment of Aspect 15, wherein the customer interface system stores a plurality of reservation baskets, each reservation basket being associated with one of the customer devices, each reservation basket including a retail location identifier and a customer identifier, each reservation basket being stored separately from a virtual shopping cart associated with the respective customer identifier.

Aspect 19. The retail location computing environment of Aspect 18, wherein the reservation basket includes at least one apparel item selected by the user.

Aspect 20. The retail location computing environment of Aspect 15, wherein the reservation system stores a plurality of timeframes, and wherein the reservation system stores at least one reservation associated with one of the timeframes, the reservation including a customer identifier and a list of one or more reserved items.

Aspect 21. The retail location computing environment of Aspect 20, wherein the reservation includes a fitting room identifier.

Aspect 22. The retail location computing environment of Aspect 20, wherein the reservation includes a list of one or more complementary items automatically generated based on the list of reserved items.

Aspect 23. A virtual shopping system comprising: a searching system configured to receive search criteria from a user and to identify articles of apparel that meet the received search criteria; a display system configured to send displays of the identified articles of apparel; a virtual reservation basket configured to track reservation requests for one or more selected ones of the displayed articles of apparel, the virtual reservation basket being in communication with a fitting room reservation system; and a virtual shopping cart configured to track purchase requests for one or more identified ones of the displayed articles of apparel, the virtual shopping cart being associated with a payment system; wherein the virtual reservation basket is not associated with a payment system.

Aspect 24. The virtual shopping system of Aspect 23, wherein the virtual reservation basket is communicatively coupled to a fitting room reservation system that schedules a fitting for the selected ones of the displayed articles of apparel.

What is claimed is:

1. A virtual shopping system comprising:
a customer interface system implemented on one or more computing devices including at least one processor communicatively coupled to at least one memory, the at least one memory storing:
a database of customer data including search data;
a virtual reservation basket database;
a virtual shopping cart database; and
instructions executable by the processor which, when executed, cause the virtual shopping system to:
communicate with a plurality of third party customer devices;
receive search criteria from the third party customer devices and to identify articles of apparel that meet the received search criteria to store as search data;
send displays of the identified articles of apparel to the third party customer devices;
receive reservation requests for one or more selected ones of the displayed articles of apparel; and
associate the one or more selected ones of the displayed articles of apparel with the virtual reservation basket database; and
track purchase requests for one or more identified ones of the displayed articles of apparel, the virtual shopping cart database being associated with a payment system;
wherein the virtual reservation basket database is not associated with a payment system.

2. The virtual shopping system of claim 1, wherein each entry of the virtual reservation basket database is associated with a customer identifier.

3. The virtual shopping system of claim 2, wherein a first entry of the virtual reservation basket database is associated with a retail location identifier.

4. The virtual shopping system of claim 3, wherein each retail location identifier is parsed from the received search criteria from the third party customer devices.

5. The virtual shopping system of claim 3, wherein the first entry of the virtual reservation basket database includes an identifier of at least one of the identified articles of apparel.

6. The virtual shopping system of claim 3, wherein the first entry of the virtual reservation basket database includes an identifier indicating a selected timeframe.

7. The virtual shopping system of claim 1, further comprising a reservation system implemented on the one or more computing devices, the reservation system including:
a reservation database storing a plurality of reservations, each reservation including a customer name and an identifier of a reserved item of apparel; and
first communication instructions stored in the at least one memory, the first communication instructions being executable to communicate with the customer interface system to receive requests for reservations and to confirm the reservations;
add instructions stored in the at least one memory, the add instructions being executable to add a reservation to the reservation database.

8. The virtual shopping system of claim 7, wherein each reservation also includes a retail location identifier.

9. The virtual shopping system of claim 8, wherein the reservation system also includes employee communication instructions to send a message to an employee of a retail location associated with the retail location identifier to gather the reserved item of apparel.

10. The virtual shopping system of claim 7, wherein each reservation also includes a timeframe for the reservation.

11. The virtual shopping system of claim 10, wherein the timeframe includes a particular timeslot.

12. The virtual shopping system of claim 10, wherein the timeframe includes an expiration time for the reservation.

13. The virtual shopping system of claim 7, wherein each reservation also includes a fitting room identifier.

14. The virtual shopping system of claim 7, wherein each reservation also includes a complementary item identifier.

15. The virtual shopping system of claim 7, wherein the reservation system includes second communication instructions to communication with an inventory management system to determine whether a requested item of apparel is available at a requested retail location.

16. The virtual shopping system of claim 7, further comprising an inventory system implemented on one or more computing devices, the inventory system including an apparel item database storing a number of available apparel items for each retail location.

17. The virtual shopping system of claim 16, wherein the inventory system is configured to receive an availability check request from the customer interface system, the availability check request identifying a retail location and an item of apparel, to check availability of item of apparel at the retail location identified by the availability check request, and to report the availability of the item of apparel to the reservation system.

18. The virtual shopping system of claim 17, wherein the inventory system also is configured to update a status of an identified item of apparel at an identified retail location based on an update request from the reservation system.

19. A computer implemented virtual shopping method comprising:
receiving at one or more computing devices a search request including search criteria from a third party device;
sending from the one or more computing devices to the third party device a display of apparel items meeting the search criteria of the search request;
receiving at the one or more computing devices from the third party device a reservation request including an item identifier of an item of apparel and a retail location identifier;
sending from the one or more computing devices a check request to an inventory management system to determine whether the item of apparel associated with the item identifier is available at a retail location associated with the retail location identifier;
adding the item of apparel to a reservation basket stored on the one or more computing devices upon receiving a confirmation of availability from the inventory management system; and
sending from the one or more computing devices a reservation request to a reservation system to reserve at the retail location any items of apparel identified in the reservation basket.

20. The computer implemented virtual shopping method of claim 19, further comprising a reserving a fitting room at the retail location.
